(19) United States
(12) Patent Application Publication
(10) Pub. No.: US 2026/0260778 A1
(43) Pub. Date: Sep. 3, 2026

(54) INSULATED ELECTRIC WIRE, CABLE, AND METHOD FOR MANUFACTURING INSULATED ELECTRIC WIRE

(71) Applicant: Proterial, Ltd., Tokyo (JP)

(72) Inventors: Atsuro YAGUCHI, Tokyo (JP); Takanobu WATANABE, Tokyo (JP); Kazufumi SUENAGA, Tokyo (JP)

(21) Appl. No.: 19/551,345

(22) Filed: Feb. 26, 2026

(30) Foreign Application Priority Data
Feb. 28, 2025 (JP) 2025-031218

(51) Int. Cl. H01B 3/44; C08F 16/24; H01B 13/14

(52) U.S. Cl. CPC H01B 3/445; C08F 16/24; H01B 13/14

(57) ABSTRACT

An insulated electric including a conductor, an insulator covering a periphery of the conductor, and an outer diameter of 0.1 mm or less, wherein the insulator is made of a resin composition mainly composed of fluororesin and has a thickness 10 μm or more and 30 μm or less, and wherein a crush strength measured by a method according to UL 2556 standard is 15 N/50 mm or more.

### CROSS-REFERENCE TO RELATED APPLICATIONS

The present application is based on Japanese patent application No. 2025-031218 filed on Feb. 28, 2025, the entire contents of which are incorporated herein by reference.

### TECHNICAL FIELD

The present invention relates to an insulated electric wire, a cable, and a method for manufacturing an insulated electric wire.

### BACKGROUND OF THE INVENTION

Cables used for endoscopes and catheters are desired to have as small a diameter as possible to minimize patient burden. Such cables employ insulated electric wires with an extremely fine diameter, for example, with a diameter of 0.10 mm or less.

For the aforementioned insulated electric wires with an extremely fine diameter, magnet wires have conventionally been used, in which enamel coating made of polyurethane or the like is applied around the conductors and baked to form the insulators. However, the magnet wires had an issue that the conductors were annealed by the heat during the high-temperature heat treatment required for baking the enamel coating, resulting in a decrease in tensile strength of the conductors.

To solve the above problem, using an insulated electric wire in which an insulator is formed by covering around a conductor with fluororesin by extrusion molding may be considered. The fluororesin can be formed into a thin wall, and its molding temperature is lower than the temperature during the heat treatment of the enamel coating. Therefore, the decrease in the tensile strength of the conductor due to annealing is suppressed, while a small outer diameter for the insulated electric wire is maintained, and as a result, an insulated electric wire that is less prone to breakage can be provided.

Patent Literature 1 is a prior art literature related to the invention of the present application.

### CITATION LIST

Patent Literature 1: U.S. patent Ser. No. 12/040,108

### SUMMARY OF THE INVENTION

However, to achieve insulated electric wires with an extremely fine diameter, such as those with an outer diameter of 0.10 mm or less, it is necessary to form an extremely thin insulator made of fluororesin. However, forming the extremely thin insulator caused the problem that the insulator becomes less resistant to external damage and prone to tearing under external force. Consequently, the insulator was likely to be damaged during processes such as twisting insulated electric wires together or terminal processing. Thus, countermeasures to address the problem have been needed.

Accordingly, it is an object of the present invention to provide an insulated electric wire having an insulator with improved resistance to damage in spite of its extremely thin diameter, a cable, and a method for manufacturing an insulated electric wire.

In order to solve the above problem, one aspect of the present invention provides an insulated electric wire, comprising:
a conductor;
an insulator covering a periphery of the conductor; and
an outer diameter of 0.1 mm or less,
wherein the insulator comprises a resin composition mainly composed of fluororesin and a thickness 10 μm or more and 30 μm or less, and
wherein a crush strength measured by a method according to UL 2556 standard is 15 N/50 mm or more.

Further, in order to solve the above problem, another aspect of the present invention provides a cable including the above insulated electric wire.

Still further, in order to solve the above problem, still another aspect of the present invention provides a method for manufacturing an insulated electric wire comprising a conductor, an insulator covering a periphery of the conductor, and an outer diameter of 0.1 mm or less, the method comprising:
providing the insulator comprising a resin composition mainly composed of fluororesin by extrusion molding around the conductor,
wherein the extrusion molding is performed with a molding temperature being +5° C. or more and +25° C. or less relative to a melting point of the fluororesin and a preheat temperature of the conductor being equal to or above the melting point of the fluororesins, to provide the insulator a thickness of 10 μm or more and 30 μm or less.

### Advantageous Effects of the Invention

According to the present invention, it is possible to provide an insulated electric wire having an insulator with improved resistance to damage in spite of its extremely thin diameter, a cable, and a method for manufacturing an insulated electric wire.

### BRIEF DESCRIPTION OF THE DRAWINGS

FIG. 1 is a cross-sectional view perpendicular to a longitudinal direction of an insulated electric wire according to an embodiment of the present invention.

FIG. 2 shows an example of a Raman spectrum of an insulator.

FIG. 3 is a diagram explaining a method for manufacturing the insulated electric wire.

FIGS. 4A and 4B are cross-sectional views showing an example of a cable using the insulated electric wire.

FIG. 5 is a cross-sectional view showing an example of a cable using the insulated electric wire.

### DETAILED DESCRIPTION OF THE INVENTION

### Embodiment

The following describes an embodiment of the present invention with reference to the accompanying drawings.

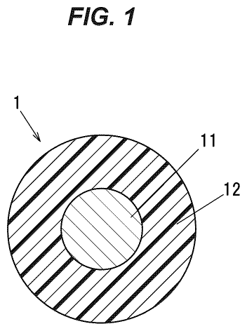

FIG. 1 is a cross-sectional view perpendicular to the longitudinal direction of an insulated electric wire 1 according to the present embodiment. The insulated electric wire 1 is used as a core wire for cables that are employed, for example, in endoscopes or catheters, and has an outer diameter extremely small, 0.10 mm or less.

The insulated electric wire 1 comprises a conductor 11 and an insulator 12 covering a periphery of the conductor 11. The conductor 11 is formed of a single solid wire. It is preferable to use the conductor 11 made of a hard copper alloy with high tensile strength. In the present embodiment, the conductor 11 is made of a silver-plated copper alloy. More specifically, it is desirable for the tensile strength of the conductor 11 to be 700 MPa or more. This configuration makes the conductor 11 less prone to breakage even when made with a small diameter. To enhance the overall tensile strength of the insulated electric wire 1, it is desirable that the outer diameter of the conductor 11 be ½ or more of the outer diameter of the insulated electric wire 1. Here, the outer diameter of the conductor 11 is 0.04 mm, and the outer diameter of the insulated electric wire 1 is 0.07 mm.

The insulator 12 is formed from a resin composition mainly composed of fluororesin and is configured by extrusion molding. As fluororesins for the insulator 12, PFA (perfluoroalkoxy alkane), FEP (tetrafluoroethylene-hexafluoropropylene copolymer), and ETF E (tetrafluoroethylene-ethylene copolymer) are suitable. In particular, it is desirable to use PFA or FEP, which exhibit good insulation performance when thinned.

The thickness of the insulator 12 is preferably 10 μm or more and 30 μm or less. Setting the thickness of the insulator 12 to 10 μm or more improves the mechanical strength of the insulator 12. Also, setting the thickness of the insulator 12 to 30 μm or less suppresses the diameter growth in the insulated electric wire 1.

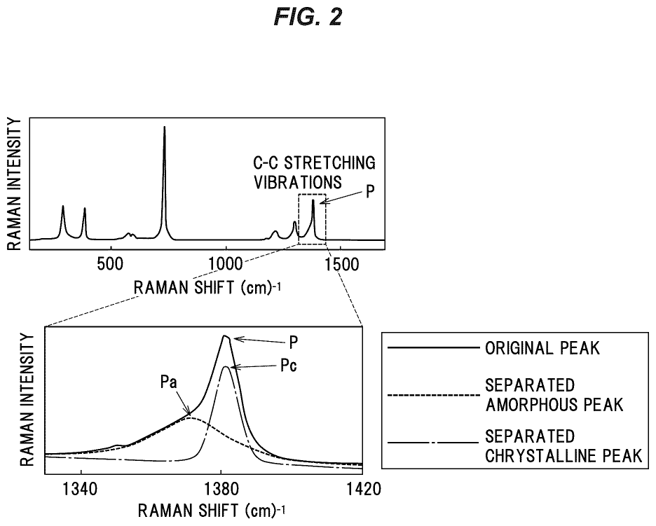

FIG. 2 shows an example of a Raman spectrum obtained with the insulator 12 (Nichias Technical Report No. 393, 2nd Issue in 2021, page 7). As shown in FIG. 2, when PFA is used as the fluororesin, the peak P in the Raman spectrum, attributed to C-C stretching vibrations, consists of two components: peak Pc which is originating from a crystalline component of PFA with a Raman shift in the range of 1365 cm⁻¹ to 1387 cm⁻¹ (referred to as a crystalline peak), and peak Pa which is originating from an amorphous component of PFA with a Raman shift in the range of 1343 cm⁻¹ to 1365 cm⁻¹ (referred to as an amorphous peak). It is desirable that the insulator 12 have a crystallinity degree Ic/Ia of 1.56 or greater, which is a ratio of an intensity Ic of the crystalline peak Pc to an intensity Ia of the amorphous peak Pa. Having a crystallinity degree Ic/Ia of 1.56 or more for the insulator 12 increases the proportion of crystallized PFA within the insulator 12, thereby improving its resistance to external damage.

The insulated electric wire 1 according to the present embodiment has the crush strength of 15 N/50 mm or more, which conforms to the UL 2556 standard. This improves the resistance to external damage of the insulator 12. To determine the crush strength, a pair of metal plates arranged facing each other is used. The insulated electric wire 1 is placed on the lower plate, and the upper plate is gradually moved downward to compress the insulated electric wire 1 between the pair of plates. The crush strength is a load applied between the pair of plates when the insulated electric wire 1 is crushed by compression, causing the metal plates to contact the conductor 11, and electrical continuity is established.

Furthermore, in the insulated electric wire 1 according to the present embodiment, TB/OD, which is a value of a tensile breaking load TB of the entire insulated electric wire 1 including the conductor 11 and the insulator 12 divided by an outer diameter OD of the insulator 12 (i.e., an outer diameter of the insulated electric wire 1), is 10 N/mm or more. This enables the realization of the insulated electric wire 1 that is fine in diameter yet resistant to breakage.

### (Method for Manufacturing the Insulated Electric Wire 1)

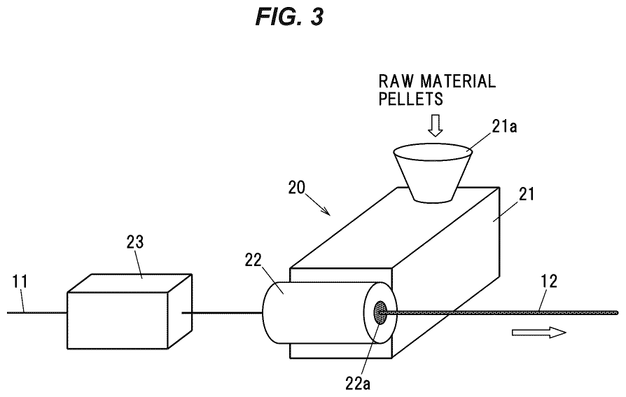

FIG. 3 is a diagram explaining a method for manufacturing the insulated electric wire 1. As shown in FIG. 3, when manufacturing the insulated electric wire 1, the extrusion molding process is performed to form the insulator 12 around the conductor 11 using an extruder 20. In the extrusion molding process, first, raw material pellets are fed into a hopper 21a of the extruder 20. The pellets are then kneaded by the screw inside an extruder body 21, and the molten resin is extruded through a die 22a via a crosshead 22. In the present embodiment, the raw material pellets are made of a resin composition mainly composed of fluororesin (here, PFA).

The resin extruded from the die 22a is coated on a surface of the conductor 11 which is moving along a travel line. Cooling the resin coated on the conductor 11 forms the insulator 12, yielding the insulated electric wire 1. In the present embodiment, an insulator 12 with a thickness of 10 μm or more and 30 μm or less is formed by extrusion molding, thereby producing the insulated electric wire 1 with the outer diameter of 0.10 mm or less. Hereinafter, the term “fluororesin” shall refer to the fluororesin used for the insulator 12.

The inventors of the present invention found that if the molding temperature during the extrusion molding is too high, the melt viscosity of the resin becomes excessively large, causing the outer diameter of the insulated electric wire 1 to become unstable. Furthermore, it was found that if the molding temperature during the extrusion molding is set too low, molding distortion increases although the outer diameter of the insulated electric wire 1 stabilizes. This prevents crystals of the fluororesin (here, PFA) from growing sufficiently, thereby reducing the resistance of the insulator 12 to external damage. The “molding temperature” in the present embodiment refers to a molding temperature downstream of the extruder 20, which is a temperature close to that of the resin extruded from the extruder 20. More specifically, it refers to a temperature of the crosshead 22 and a mold (a nozzle and the die 22a) that are installed at the end of the extruder 20.

Further investigation by the inventors revealed that even when the molding temperature is set relatively low, if the conductor 11 is sufficiently preheated (heated) before the extrusion molding, the molding distortion can be suppressed and the resistance of the insulator 12 to external damage can be improved. Therefore, the present embodiment has a configuration where a preheating device 23 is provided to preheat the conductor 11 before being introduced into the extruder 20.

More specifically, the molding temperature in the extruder 20 is set to a relatively low range from 5° C. to 25° C. above the melting point of the fluororesin. In addition, the preheating device 23 preheats the conductor 11 to a temperature at or above the melting point of the fluororesin before being introduced into the extruder 20. It is sufficient if the temperature of the conductor 11 when entering the extruder 20 is at or above the melting point of the fluororesin. When using PFA as the fluororesin, since PFA's melting point is approximately 300° C. to 310° C., it is preferable to set the temperature of the preheating device 23 in such a manner that the temperature of the conductor 11 is at least 310° C. when entering the extruder 20. In the present embodiment, the conductor 11 is preheated to 350° C. in the preheating device 23, and the molding temperature in the extruder 20 is set to 315° C. The preheating temperature of the conductor 11 in the preheating device 23 is set higher than the molding temperature in the extruder 20.

Also, in the present embodiment, a screw rotation speed was set to 0.5 rpm, and a linear speed was set to 23 m/min. Additionally, the resin after the extrusion molding was cooled by inline air cooling at a temperature of 20° C. or more and 25° C. or less instead of water cooling, to form the insulator 12, thereby obtaining the insulated electric wire 1. Note that the resin after the extrusion molding retains molding distortion. Rapid water cooling in this state suppresses molecular motion of PFA molecules, causing the insulator 12 to be formed retaining the distortion, which makes the insulator 12 prone to external damage. Therefore, in the present embodiment, the resin after the extrusion molding is not rapidly water-cooled but is slowly cooled by air cooling. This enables the resin to return to a state where the molding distortion is mitigated, since the molecular motion of the PFA molecules in the resin after the extrusion molding remains unrestricted. Consequently, the residual molding distortion in the insulator 12 is suppressed, making the insulator 12 less prone to external damage.

### (Cable 3 Using the Insulated Electric Wire 1)

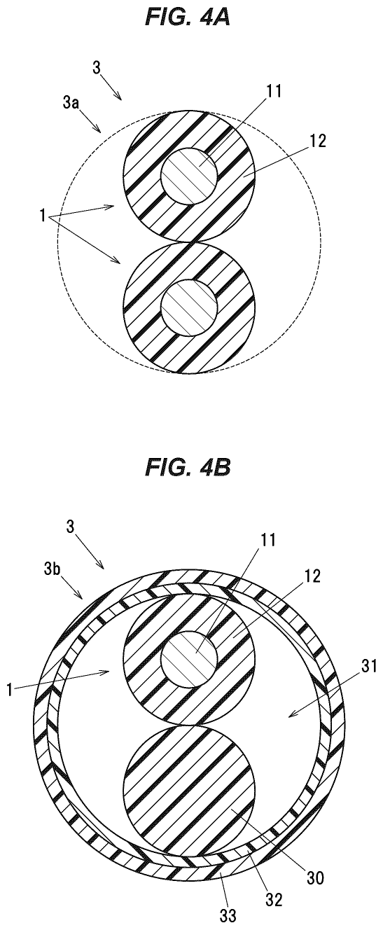

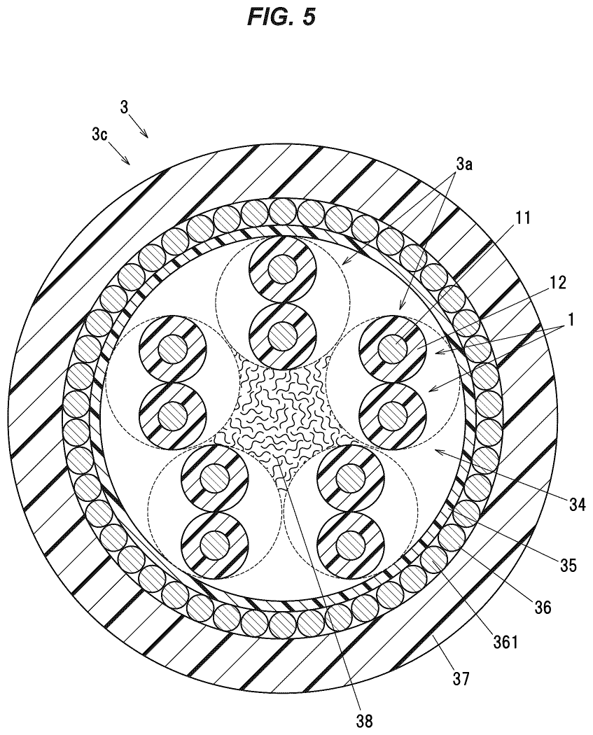

FIGS. 4A, 4B, and 5 are cross-sectional views showing an example of a cable 3 including the insulated electric wire 1.

The cable 3 shown in FIG. 4A is a twisted wire 3a formed by twisting together two insulated electric wires 1. In an example of FIG. 4A, no other components are provided around the two insulated electric wires 1. However, for example, a jacket or the like may be provided to cover around the two insulated electric wires 1 collectively. It is also possible to form the cable 3 by twisting together two or more insulated electric wires 1.

The cable 3b shown in FIG. 4B comprises an assembly 31 formed by twisting together one insulated electric wire 1 and a tension member (tensile fiber) 30, a binder tape 32 spirally wound around the assembly 31, and a jacket 33 covering a periphery of the binder tape 32. The tension member 30 may be made of, for example, liquid crystal polyester. The binder tape 32 may be made of, for example, a resin tape. Here, a copper polyester tape with a thickness of 0.01 mm was used as the binder tape 32, in which a copper metal layer was formed on one side of a polyester resin tape. In this case, the metal layer of the binder tape 32 functions as a shielding layer. The jacket 33 is formed by spirally winding a resin tape around the binder tape 32. Here, a 0.01 mm thick resin tape made of polyester was used to form the jacket 33. An outer diameter of the cable 3b is 0.22 mm.

The assembly 31 may include two or more insulated electric wires 1. For example, the assembly 31 may be formed by arranging two insulated electric wires 1 and the tension member 30 alternately in the circumferential direction of the cable 3b.

Cable 3c shown in FIG. 5 comprises an assembly 34 formed by twisting together five twisted pairs 3a, a binder tape 35 spirally wound around a periphery of the assembly 34, a shield layer 36 covering a periphery of the binder tape 35, and a sheath 37 covering a periphery of the shield layer 36.

The assembly 34 is formed by twisting together fiber inclusion 38 and five twisted pairs 3a. More specifically, the assembly 34 is formed by placing the fiber inclusion 38 at a cable center and arranging the five twisted pairs 3a circumferentially around the fiber inclusion 38. The fiber inclusion 38 comprises a bundle of resin fibers. As the resin fibers constituting the fiber inclusion 38, for example, resin fibers made of liquid crystal polyester can be used. As the binder tape 35, for example, a resin tape can be used. Here, a resin tape made of polyimide with a thickness of 0.40 mm was used as the binder tape 35.

The shield layer 36 comprises a spiral wound shield formed by spirally winding a plurality of metal strands 361. The metal strands 361 used here have an extremely fine diameter with an outer diameter of 0.05 mm. To suppress breakage of the metal strands 361 and improve conductivity, it is preferable to use silver-plated copper alloy wires as the metal strands 361. Here, the shield layer 36 was formed using the metal strands 361 made of silver-plated copper alloy wires with an outer diameter of 0.03 mm. The sheath 37 is preferably made of fluororesins, which can be molded into thin walls. Here, the sheath 37 made of PFA with a thickness of 0.05 mm was used. The outer diameter of the cable 3c is 0.56 mm.

### EXAMPLE

The insulated electric wire 1 was prototyped in Example, in which the insulator 12 made of PFA (P-61XP, AGC Inc.) with a thickness of 0.015 mm was formed around the conductor 11 with an outer diameter of 0.04 mm, by using the extruder 20 with a core diameter of 2.5 mm, a die diameter of 4.0 mm, and a screw diameter of 15 mm. The extrusion molding conditions were: molding temperature 315° C., screw rotation speed 0.5 rpm, and wire speed 23 m/min. After the extrusion molding, the resin was cooled using inline air cooling at a temperature of 20° C. or more and 25° C. or less to form the insulator 12 instead of water cooling, yielding the insulated electric wire 1 shown in FIG. 1. In addition, in Example, the conductor 11 was preheated to 350° C. by the preheating device 23 before being introduced into the extruder 20.

The insulated electric wire 1 obtained in Example underwent a crush test conforming to UL 2556, which is a UL standard, to determine crush strength, as well as measurement of tensile strength. Furthermore, a Raman spectrum measurement was performed on the insulator 12 of the insulated electric wire 1 to determine the crystallinity degree.

Furthermore, the cable 3c shown in FIG. 5 was prototyped using the insulated electric wire 1 in Example. First, two insulated electric wires 1 were twisted together with a twist pitch of 0.5 mm to form the twisted wire 3a. Then, five twisted wires 3a were twisted together with the fiber inclusion 38 composed of liquid crystal polyester 440dTEX to form the assembly 34. When twisting the assembly 34, a planetary twisting machine with a die diameter of 0.5 mm and a rotation speed of 50 rpm was used. Subsequently, the binder tape 35 made of polyimide with a width of 2.2 mm was wrapped around the assembly 34, the shield layer 36 was formed around the binder tape 35, and a sheath 37 made of PFA was formed around the shield layer 36 by extrusion molding at a molding temperature of 315° C. Then the resistance between the conductors 11 of the two insulated electric wires 1 constituting the twisted wire 3a was measured on the obtained cable 3c. If the measured resistance was low, it was considered that external damage had occurred to the insulator 12 during the manufacturing process of the cable 3c. Furthermore, the cable 3c was disassembled, and a visual inspection was performed to confirm whether any damage existed on the insulator 12 of the insulated electric wire 1.

Additionally, an insulated electric wire was prototyped as a comparative example in the same conditions as the Example, except that the conductor 11 was not heated before being introduced into the extruder 20. Then, the measurements of crush strength, tensile strength (tensile breaking load), and crystallinity degree were performed on the insulated electric wire. Furthermore, a cable was prototyped in the same manner as the Example using the insulated electric wire prototyped as the comparative example. Then the resistance between the conductors 11 was measured, and a visual inspection was conducted to confirm the presence or absence of external damage to the insulator 12. The results are summarized in Table 1.

TABLE 1

| | Example | Comparative Example |
|---|---|---|
| Crush Strength (N/50 mm) | 34 | 11.5 |
| Tensile Breaking Load TB (N) | 1.32 | 1.39 |
| Tensile Breaking Load TB/ | 18.86 | 19.86 |
| Outer Diameter OD | | |
| (N/mm) | | |
| Crystallinity Degree | 1.71 | 1.55 |
| Insulator Resistance Between | 10000 | 1.03 |
| Conductors (Mohm-km) | | |
| External Damage on Insulator | No | Yes |

As shown in Table 1, it can be confirmed that the crush strength in the Example is 15 N/50 mm or more, whereas it is lower than 15 N/50 mm in the comparative example. It can be also confirmed that the crystallinity degree in the insulator 12 is 1.56 or higher in the Example, whereas it is lower than 1.56 in the comparative example. In the Example where the crush strength is sufficiently high and the crystallinity degree in the insulator 12 is also high, it was confirmed that no damage occurred to the insulator 12 during the formation of the cable 3c, and the insulation resistance between the conductors 11 was maintained. On the contrary, in the comparative example with low crush strength and low crystallinity degree in the insulator 12, damage to the insulator 12 occurred during the cable formation, and the insulation resistance between the conductors 11 became extremely low. Note that the insulation resistance between the conductors 11 is preferably at least 1000 Mohm-km or higher. Furthermore, regarding TB/OD, which is a value of the tensile breaking load TB divided by the outer diameter OD of the insulator 12 of the insulated electric wire 1, both the Example and the comparative example exhibited a value of 10 N/mm or higher, confirming that the resistance to breakage was maintained.

### Functions and Effects of the Embodiment

As described above, in the insulated electric wire 1 according to the present embodiment, the insulator 12 comprises a resin composition mainly composed of fluororesin, the thickness of the insulator 12 is 10 μm or more and 30 μm or less, and the crush strength measured by a crush test conforming to the UL 2556, which is a UL standard, is 15 N/50 mm or more.

By configuring it in this manner, it becomes possible to improve the resistance of the insulator 12 to external damage while maintaining an extremely small diameter. As a result, damage to the insulator 12 is less likely to occur during operations such as twisting the insulated electric wire 1 or terminal processing, which facilitates handling of the insulated electric wire 1 and enables suppression of yield loss.

### Summary of the Embodiments

Next, technical ideas understood from the above embodiment will be described with reference to the reference numerals and the like used in the embodiment. However, each reference numeral in the following description does not limit the constituent elements in the scope of claims to the members and the like specifically shown in the embodiments.

According to the first feature, an insulated electric wire 1, includes a conductor 11; an insulator 12 covering a periphery of the conductor 11; and an outer diameter of 0.1 mm or less, wherein the insulator 12 comprises a resin composition mainly composed of fluororesin and a thickness of 10 μm or more and 30 μm or less, and wherein a crush strength measured by a method according to the UL 2556 standard is 15 N/50 mm or more.

According to the second feature, in the insulated electric wire 1 as described by the first feature, TB/OD, which is a value of tensile breaking load TB of the insulated electric wire including the conductor 11 and the insulator 12 divided by an outer diameter OD of the insulator 12, is 10 N/mm or more.

According to the third feature, in the insulated electric wire 1 as described by the second feature, the tensile strength of the conductor 11 is 700 MPa or more.

According to the fourth feature, in the insulated electric wire 1 as described by the first feature, the fluororesin is PFA (perfluoroalkoxy alkane), and the insulator 12 has a crystallinity degree Ic/Ia of 1.56 or more, which is a ratio of a crystalline peak intensity Ic originating from a crystalline component of PFA, with a Raman shift in a range of 1365 cm⁻¹ or more and 1387 cm⁻¹ or less, to an amorphous peak intensity Ia originating from an amorphous component of PFA, with a Raman shift in the range of 1343 cm⁻¹ or more and 1365 cm⁻¹ or less, among the peaks attributed to C-C stretching vibrations in a Raman spectrum.

According to the fifth feature, a cable 3 includes the insulated electric wire 1 as described by any one of the first to fourth features.

According to the sixth feature, a method for manufacturing an insulated electric wire including a conductor 11 and an insulator 12 covering a periphery of the conductor 11 and having an outer diameter of 0.1 mm or less, includes an extrusion molding step of providing the insulator 12 formed from a resin composition mainly composed of fluororesin by extrusion molding around the conductor 11, wherein, in the extrusion molding step, a molding temperature is from +5° C. to +25° C. relative to a melting point of the fluororesin, wherein the conductor 11 is preheated to a temperature equal to or above the melting point of the fluororesin before performing the extrusion molding, and wherein the insulator 12 with a thickness of 10 μm or more and 30 μm or less is formed thereby.

That is all for the explanation of the embodiments according to the present invention. However, the embodiments described above do not limit the invention claimed in the claims. It should also be noted that not all combinations of features described in the embodiments are necessarily essential means for solving the problems of the invention. Furthermore, the present invention may be appropriately modified and implemented within the scope that does not deviate from its spirit.

1. An insulated electric wire, comprising:
a conductor;
an insulator covering a periphery of the conductor; and
an outer diameter of 0.1 mm or less,
wherein the insulator comprises a resin composition mainly composed of fluororesin and a thickness 10 μm or more and 30 μm or less, and
wherein a crush strength measured by a method according to UL 2556 standard is 15 N/50 mm or more.

2. The insulated electric wire, according to claim 1, wherein TB/OD, which is a value of a tensile breaking load TB of the insulated electric wire including the conductor and the insulator divided by an outer diameter OD of the insulator, is 10 N/mm or more.

3. The insulated electric wire, according to claim 2, wherein a tensile strength of the conductor is 700 MPa or more.

4. The insulated electric wire, according to claim 1, wherein the fluororesin is PFA (perfluoroalkoxy alkane), and wherein the insulator has a crystallinity degree Ic/Ia of 1.56 or more, which is a ratio of a crystalline peak intensity Ic originating from a crystalline component of PFA, with a Raman shift within a range of 1365 cm⁻¹ or more and 1387 cm⁻¹ or less, to an amorphous peak intensity Ia originating from an amorphous component of PFA, with a Raman shift within a range of 1343 cm⁻¹ or more and 1365 cm⁻¹ or less, among peaks attributed to C-C stretching vibrations in a Raman spectrum.

5. A cable including the insulated electric wire according to claim 1.

6. A method for manufacturing an insulated electric wire comprising a conductor, an insulator covering a periphery of the conductor, and an outer diameter of 0.1 mm or less, the method comprising:
providing the insulator comprising a resin composition mainly composed of fluororesin by extrusion molding around the conductor,
wherein the extrusion molding is performed with a molding temperature being +5° C. or more and +25° C. or less relative to a melting point of the fluororesin and a preheat temperature of the conductor being equal to or above the melting point of the fluororesins, to provide the insulator a thickness of 10 μm or more and 30 μm or less.
